(19) United States
(12) Patent Application Publication
(10) Pub. No.: US 2005/0248044 A1
(43) Pub. Date: Nov. 10, 2005

(54) Wall-mounted ultrasonic humidifier

(76) Inventor: Young-Oh Kim, Seoul (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/122,404

(22) Filed: May 5, 2005

(30) Foreign Application Priority Data
May 6, 2004 (KR) 20-2004-12622

(51) Int. Cl. B01F 3/04

(52) U.S. Cl. 261/81; 261/DIG. 48

(57) ABSTRACT

There is provided a humidifier comprising: a base including a plate member mounted on a wall and a support member perpendicularly extending from the plate member; a body having a mounting plate and a side wall member perpendicularly extending from the mounting plate, wherein a boss protrudes from the mounting plate and is formed through the mounting plate, and wherein the boss is fitted around the support member; a water tank formed on the mounting plate and having a storage space for storing water therein, the water tank further having a discharging passageway communicating with an outside of the humidifier; a water-supply tube connected to a water source at its one end while other end thereof is connected to the water tank; a transducer for converting the water in the water tank into mist; and a blower for providing an air flow which moves the mist to the outside through the discharging passageway. An automatic water-feeding system is provided in the humidifier.

### FIELD OF THE INVENTION

The present invention generally relates to a humidifier, and more particularly to a wall-mounted ultrasonic automatic water-feeding humidifier having a base and a body, which can be assembled with each other through a thread engagement between a male thread of the base and a female thread of the body, thereby allowing an easy installation of the humidifier on the wall side as well as a transducer configured to be easily removed from and mounted to the humidifier.

### BACKGROUND OF THE INVENTION

A conventional general humidifier, which is used in home and offices, has an unusually large size due to the size of the water tank inside the humidifier. Reducing the size of the water tank used in the humidifier is desirable in order to reduce the size of the humidifier. In such a case, however, the water supply to the humidifier has to be performed more frequently as the size of the water tank is reduced, thus making it inconvenient to use the humidifier.

If the humidifier is placed on the floor of a room, then the mist emitted from the humidifier is not distributed evenly throughout the room or the humidifier may be knocked down by the users' activities in the room. For these reasons, the humidifier placed on the floor cannot be expected to perform its essential function well. In order to avoid such problems, the humidifiers are typically installed on a supporting member or a table having a height of approximately one meter from the floor. However, since the mist cannot be optimally distributed at this height, the humidifiers are often placed at the center of the room in order for the mist to be more evenly distributed throughout the room.

As described above, the conventional humidifiers have several shortcomings such as limitation on reducing the size of the humidifier or limitation on location of the humidifier. Especially, the humidifier is often required to be located at the center of the room, which is a space often used for other important purposes.

### SUMMARY OF THE INVENTION

In order to overcome the aforementioned shortcomings, it is an object of the present invention to provide a small-sized wall-mounted automatic water-feeding humidifier.

A second object of the present invention is to provide a humidifier that can be easily assembled and installed.

A third object of the present invention is to provide a transducer, which can be easily separated from the humidifier and easily mounted thereto, in order to facilitate the maintenance of the transducer (e.g., repair or cleaning).

In order to achieve the first and second objects of the present invention, there is provided a humidifier comprising: a base including a plate member mounted on a wall and a support member perpendicularly extending from the plate member; a body having a mounting plate and a side wall member perpendicularly extending from the mounting plate, wherein a boss protrudes from the mounting plate and is formed through the mounting plate, and wherein the boss is fitted around the support member; a water tank formed on the mounting plate and having a storage space for storing water therein, the water tank further having a discharging passageway communicating with an outside of the humidifier; a water-supply tube connected to a water source at one end while other end thereof is connected to the water tank; a level control means for maintaining a level of water in the water tank within a predetermined range by controlling an amount of water being supplied into the water tank from the water source; a transducer for converting the water in the water tank into mist; and a blower for providing an air flow which moves the mist to the outside through the discharging passageway.

In order to achieve the third object of the present invention, there is provided a humidifier comprising a subsidiary storage space provided in the water tank and communicating with the storage space, wherein the water stored in the storage space is moved to the subsidiary storage space when the body is rotated by a predetermined angle. The water tank comprises a hole through which the storage space communicates with the outside of the water tank. Further, the transducer is detachably and air-tightly engaged with the hole.

In one aspect of the present invention, the level control means comprises water level sensors for sensing water levels in the storage space to generate corresponding signals, a water-supply valve mounted to the water-supply tube to shut-off the water supply or allow the water to be supplied from the water source to the water tank, and a controller for controlling the water-supply valve according to the signals from the water level sensors. Further, the humidifier comprises a power-off sensor for sensing the water level exceeding said predetermined range to generate signals for the controller to turn-off the humidifier, wherein the water-supply valve is an electronic solenoid valve configured such that a plunger shuts-off the water-supply tube when the power is disconnected from the electronic solenoid valve.

### BRIEF DESCRIPTION OF THE DRAWINGS

The above and other objects of the present invention will become apparent from the following description of preferred embodiments given in conjunction with the accompanying drawings, in which:

FIG. 1 is a front elevational view of a humidifier in which its cap member is removed in accordance with the present invention;

FIG. 2 is a sectional view of the humidifier shown in FIG. 1, when taken along a line 2-2′, together with the cap member, in which electric cables are omitted;

FIG. 3 is a partially cut-away view of the humidifier shown in FIG. 1;

FIG. 4 is a front elevational view of the humidifier for illustrating the process of exchanging a transducer; and

FIG. 5 is a sectional view of a water-supply valve.

### DETAILED DESCRIPTION OF THE PRESENT INVENTION

A preferred embodiment of the present invention will now be described below with reference to accompanying drawings.

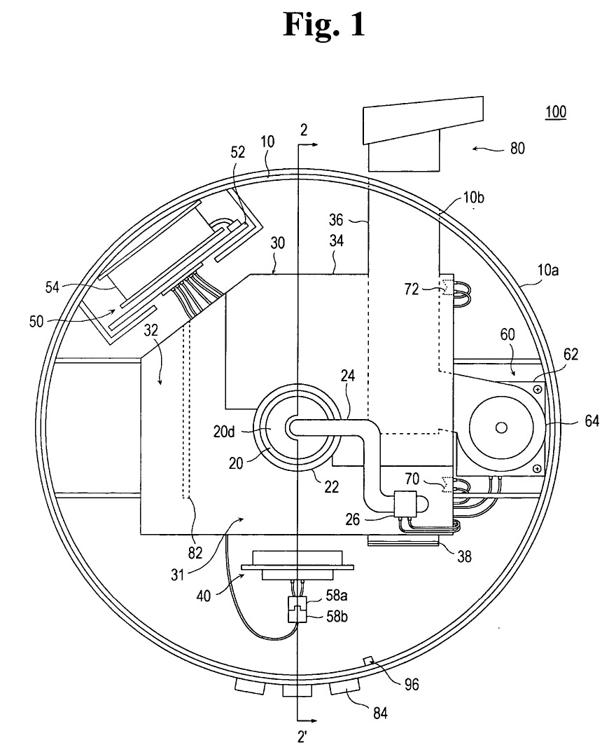

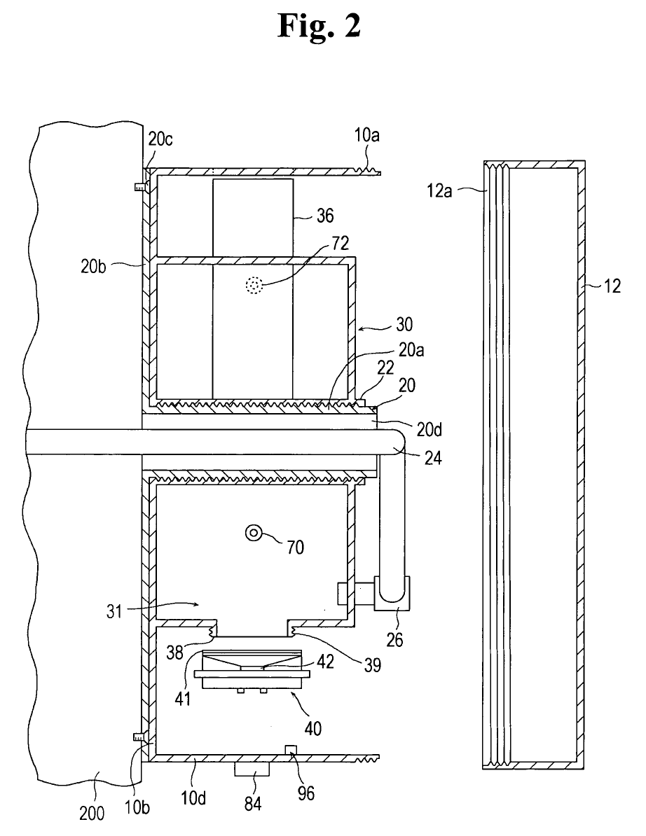

Referring to FIGS. 1 and 2, a humidifier 100 of the present invention includes a cylindrical body 10 having various components therein, The humidifier 100 of the present invention further includes a base 20 mounted to a wall 200 and engaged with the cylindrical body 10 through a thread engagement therebetween.

As illustrated in FIG. 2, the cylindrical body 10 includes a mounting plate 10b, which comes into contact with the flange 20b, and a side wall 10d perpendicularly extending from the mounting plate 10b. A water tank 30 is formed on the mounting plate 10b. A boss 22 is formed through the mounting plate 10b and the water tank 30, and is provided with a female thread formed thereinside.

The base 20 has a hollow thread tube 20a having a male thread on its external surface, which can be engaged with the female thread, and a flange 20b perpendicularly extending from one end of the thread tube 20a. The flange 20b is mounted on the wall 200 of the room by means of a screw 20c. Although the height of a place to which the flange 20b is mounted is not limited to a certain value, it is preferable that the flange 20b is mounted on a portion of the wall close to the ceiling. This is because if the humidifier 100 is located at a high position, then it does not obstruct the user's activities while the mist emitted therefrom can be spread throughout the room.

A water-supply tube 24 extends through an inner part 20d of the hollow thread tube 20a. The water-supply tube 24 is connected at its one end to a water source (e.g., a water supply facility of a building) through a decompression device (not shown), while the other end is connected to the water tank 30. Alternatively, the water-supply tube 24 may be connected to a water supply pipe of a sprinkler, which is installed at the ceiling of the building, as the water source.

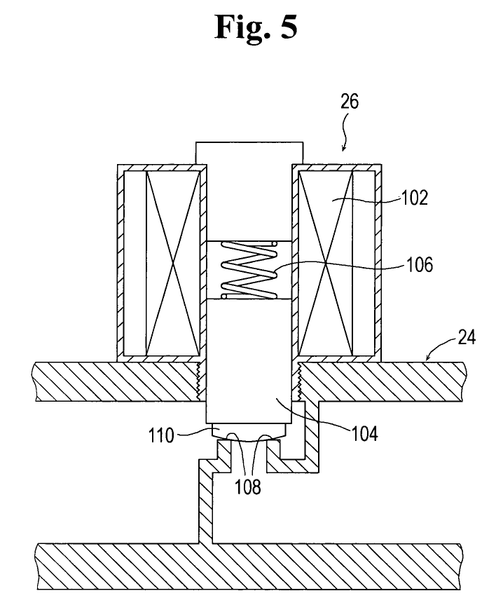

A water-supply valve 26 mounted to the water-supply tube 24 can control the amount of water supplied into the water tank 30. The water-supply valve 26 can be embodied with an electronic solenoid valve (shown in FIG. 5), which is well known to those skilled in the art.

As shown in FIG. 5, the electronic solenoid valve used in the present invention is configured such that a plunger 104 is moved downward by the force of a spring 106. Thus, a passageway of the water-supply tube 24 is closed by the contact between a valve face 110 and a valve seat 108 when the valve 26 is electrically disconnected from a power source. When the valve 26 is electrically switched-on, the plunger 104 is moved upward by a magnetic force caused by a coil 102.

Referring now back to FIG. 2, the body 10 can be joined to the base 10 through the thread engagement between the female thread of the boss 22 and the male thread of the base 10. The body 10 can also be thread-joined to a cap member 12. For this, additional male thread 10a and female thread 12a are formed at the body 10 and the cap member 12, respectively.

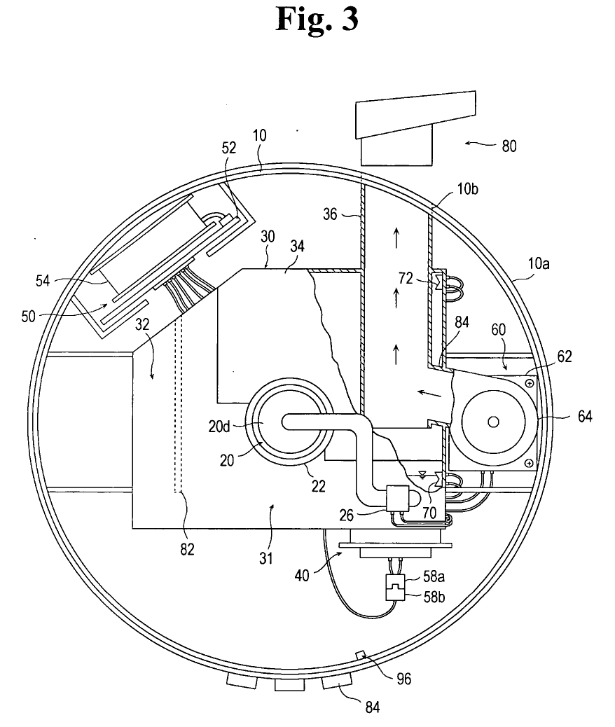

Referring to FIG. 3, the water tank 30 includes a main tank 31, a subsidiary tank 32 and a discharging duct 36.

The water supplied through the water-supply tube 24 is kept in the main tank 31 of the water tank 30.

A transducer holder 38, into which a transducer 40 can be fitted, is formed through a lower part of the main tank 31. The transducer 40, which is thread-joined to the transducer holder 38, changes the water kept in the main tank 31 into water particles or mist by using an ultrasonic wave.

As illustrated in FIG. 2, a thread 41 is formed at an upper part of the transducer 40 to a thread 39 of the holder 38. The transducer 40 and the holder 38 are air-tightly joined to each other. The transducer 40 converts water into fine mist with a vibrating plate or nebulizer 42 contained therein, and is electrically connected to the power source 50 via detachable connectors 58a and 58b.

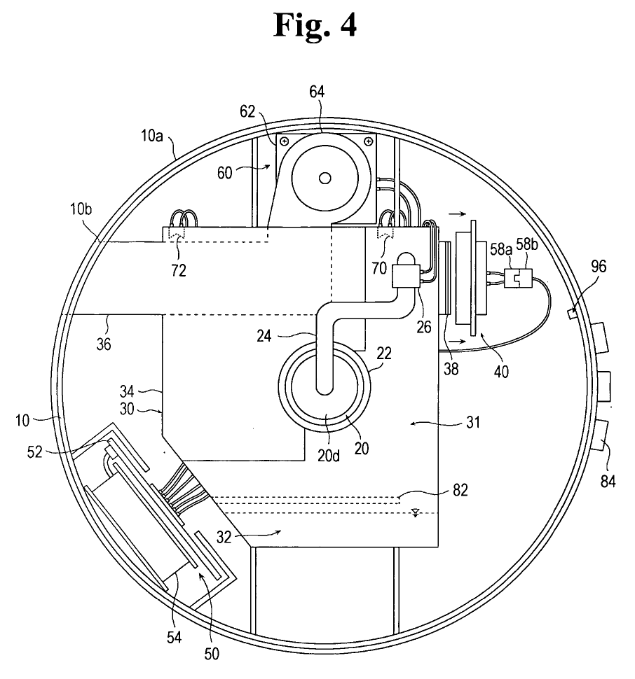

Referring to FIG. 3, the subsidiary tank 32 is used to temporarily store the water of the main tank 31 in case the transducer 40 needs to be separated from the water tank 30 for maintenance of the transducer 40 such as replacing the transducer 40 with a new one. The subsidiary tank 32 is partially partitioned from the main tank 31 with a wall 82. Rotating the body 10, which is thread-joined to the base 20, counter-clockwise about 90 degrees (as illustrated in FIG. 4) allows the water of main tank 31 to be moved to the subsidiary tank 32. By this configuration, the separation of the transducer 40 from the water tank 30 can be processed without discharging the water out of the water tank 30.

Referring to FIG. 3, the discharging duct 36 functions as a passageway through which the mist is distributed to the room. An outlet 80 for directing the mist, which is emitted from the discharging duct 35, is positioned at the end of the discharging duct 36. A through-hole 10b, into which the outlet 80 is fitted, is formed through the body 10 at a position corresponding to the discharging duct 36. An inlet, through which the air flow by a blower 64 is introduced into the discharging duct 36, is formed at a lower part of discharging duct 36. The transducer holder 38 is located right beneath the discharging duct 36. Under this construction, the mist generated by the transducer 40 is directed to the discharging duct 36 in a direction indicated by arrows. This is because a lower level of pressure is established in the discharging duct 36 by the air flow caused by the blower 64. The mist, together with the air flow, is discharged through the discharging duct 36 so as to be distributed throughout the room.

The blower 64 is mounted to the body 10 via a support plate 62 in order to form a blower assembly 60.

A pair of water level control sensors 70 is mounted to the main tank 31. The sensors 70 are used to keep the water level in the main tank 31 in a predetermined range and sense two predetermined water levels in the main tank 31 (i.e., an upper limitation level and a lower limitation level) to output corresponding signals to a printed circuit board 52. A controller implemented by the printed circuit board 52 opens the water-supply valve 26 upon receiving the signal of the lower limitation level. It can also shut-off the water-supply valve 26 upon receiving the signal of the upper limitation level to stop the water supply. It is preferable that the upper limitation level and the lower limitation level are determined so as to result in a range of the water level ranging from approximately 1 cm to 4 cm above the nebulizer 42.

A power-off sensor 72 is attached to an upper part of the main tank 31. When an abnormal rise of water level by a continuous water supply occurs due to, for example, a failure of the sensor 70, the sensor 72 detects such an abnormal rise of the water level. The power-off sensor 72 outputs the signals to the controller when it detects that the water level in the main tank 31 reaches the height of the sensor 72. Upon receiving the signals from the sensor 72, the controller disconnects the power from the water-supply valve 26. As a result, the plunger 104 is forcibly moved downward by the spring 106 in order to close the water-supply tube 24.

In the meantime, a cover 34 may be provided to the water tank 30 for easy maintenance, such as cleaning an inside of water tank 30 or replacing sensors 70, 72. As illustrated in FIG. 1, buttons 84 for various operations of the humidifier (e.g., turning-on, turning-off, adjusting the amount of the mist being distributed, adjusting humidity, etc.) are provided at the lower portion of the humidifier so that users can easily operate. Instead of the buttons 84, a remote control system for controlling the humidifier from a remote place can also apply. Reference numeral 54 means a transformer.

In accordance with the present invention, when the user manipulates one of the buttons 84 to turn off the humidifier, the operation of the humidifier may be continued for a given period of time and then stopped. More specifically, when one of the buttons 84 for turning off the humidifier is pushed by the user, the controller first closes the water-supply valve 26 to stop the supply of water and continues to convert the remaining water into mist by using the nebulizer 42 until the water remaining in the main tank 31 is completely removed. For this, the controller may be provided with a timer, which counts the elapse of time. With this process, the inventive humidifier can be kept in a more sanitary condition.

Further, the inventive humidifier may be provided with a sensor 96 for measuring humidity, which is connected to the controller. Although the sensor 96 is mounted within the humidifier, it can be positioned outside the humidifier. If the user sets the target humidity by operating one of the buttons 84, the controller starts the operation of the humidifier or maintains the current operation of the humidifier only when the humidity measured by the sensor 96 is lower than the target humidity. The controller stops the operation of the humidifier at the time when the humidity measured by the sensor 96 arrives at the target humidity.

The humidifier according to the present invention does not require a water tank having a large volume since water is continuously fed into the water tank by an automatic water-supply system. Further, since arranging the water-supply tube inside the thread tube of the base saves the space, it can be manufactured in a small size.

The inventive humidifier also presents various advantages, for example, an easy maintenance of the transducer since the transducer is exposed to a position to which a user or an operator can easily access. The transducer can be separated from the holder without evacuating the water tank after the body of the humidifier is rotated to move the water in the main tank to other space.

In accordance with the present invention, the humidifier may be easily installed in such a way that the body of the humidifier can be combined with the base through the thread engagement therebetween after the flange of the base is fixed to the wall.

The inventive humidifier may be mounted in a water purifier having an automatic water-supply function, an air conditioner or an air cleaner to allow the device to have both functions (i.e., their inherent functions and a function as a humidifier).

The inventive humidifier can be installed not only on the wall but also at the ceiling. In case the humidifier in mounted to the ceiling, a vertically extending structure is established in a behind space of the ceiling adjacent to, e.g., a sprinkler system, in order to support the humidifier. The humidifier will be kept in a same position as that in the preferred embodiment. The humidifier will be provided with an outlet having its end introduced into the room, which is longer than the outlet illustrated in the preferred embodiment.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

1. A humidifier comprising:
a base including a plate member mounted on a wall and a support member perpendicularly extending from the plate member;
a body having a mounting plate and a side wall member perpendicularly extending from the mounting plate, wherein a boss protrudes from the mounting plate and is formed through the mounting plate, and wherein the boss is fitted around the support member;
a water tank formed on the mounting plate and having a storage space for storing water therein, the water tank further having a discharging passageway communicating with an outside of the humidifier;
a water-supply tube connected to a water source at one end while other end thereof is connected to the water tank;
a level control means for maintaining a level of water in the water tank in a predetenmined range by controlling an amount of water being supplied into the water tank from the water source;
a transducer for converting the water in the water tank into mist; and
a blower for providing an air flow which moves the mist to the outside through the discharging passageway.

2. The humidifier of claim 1 comprising a subsidiary storage space provided in the water tank and communicating with the storage space, wherein the water stored in the storage space is moved to the subsidiary storage space when the body is rotated by a predetermined angle.

3. The humidifier of claim 2, wherein the water tank comprises a hole through which the storage space communicates with the outside of the water tank, wherein the transducer is detachably and air-tightly engaged with the hole.

4. The humidifier of claim 3, wherein the level control means further comprises:
water level sensors for sensing water levels in the storage space to generate corresponding signals;
a water-supply valve mounted to the water-supply tube to shut-off/allow a water supply from the water source to the water tank; and
a controller for controlling the water-supply valve according to the signals from the water level sensors.

5. The humidifier of claim 4, further comprising a power-off sensor for sensing the water level exceeding the predetermined range to generate signals for the controller to turn-off the humidifier, wherein the water-supply valve is an electronic solenoid valve configured such that a plunger shuts-off the water-supply tube when power is disconnected from the electronic solenoid valve.

6. The humidifier of claim 1, wherein, before the humidifier is turned-off, the water-supply to the water tank is stopped and the transducer is further operated until remaining water in the water tank is completely converted to the mist.
